(19) United States
(12) Patent Application Publication
(10) Pub. No.: US 2021/0062412 A1
(43) Pub. Date: Mar. 4, 2021

(54) SUEDE-LIKE ARTIFICIAL LEATHER AND PRODUCTION METHOD THEREOF

(71) Applicants: HYUNDAI MOTOR COMPANY, Seoul (KR); LG Hausys, Ltd., Seoul (KR)

(72) Inventors: Hongchan JEON, Seoul (KR); Oh-Deok KWON, Hwaseong-si (KR); Hyung-Joon YOUN, Seoul (KR); Seo-Hyeon PARK, Seoul (KR); Eun-Ho SONG, Seoul (KR); Yoo Rang HEO, Seoul (KR)

(73) Assignees: HYUNDAI MOTOR COMPANY, Seoul (KR); Kia Motors Corporation, Seoul (KR); LG Hausys, Ltd., Seoul (KR)

(21) Appl. No.: 16/688,631

(22) Filed: Nov. 19, 2019

(30) Foreign Application Priority Data
Aug. 30, 2019 (KR) 10-2019-0107332

(51) Int. Cl. D06N 3/00

(52) U.S. Cl. CPC D06N 3/0036; D06N 3/0038; D06N 3/0034; D06N 3/0009

(57) ABSTRACT

The present disclosure relates to suede-like artificial leather and a production method thereof, and more particularly, to suede-like artificial leather, which is excellent in sensibility such as smooth texture and fullness while satisfying physical properties desired as suede that is used for automotive headliners, fillers, and sun visors using a covering yarn including a core and a sea-island type microfiber surrounding the core in suede used for a vehicle interior part, and a production method thereof.

### CROSS-REFERENCE TO RELATED APPLICATIONS

This application claims priority to and the benefit of Korean Patent Application No. 10-2019-0107332, filed on Aug. 30, 2019, which is incorporated herein by reference in its entirety.

### FIELD

The present disclosure relates to suede-like artificial leather and a production method thereof, and more particularly, to suede-like artificial leather suitable for use in a headliner, a filler, and a sun visor for a vehicle, which is excellent in sensibility such as smooth texture and fullness while satisfying physical properties desired as suede that is used for a vehicle interior part using a covering yarn including a core and a sea-island type microfiber surrounding the core in suede used for a vehicle interior part, and a production method thereof.

### BACKGROUND

The statements in this section merely provide background information related to the present disclosure and may not constitute prior art.

Since a skin material that forms the surface of a vehicle interior part is an area that is confirmed by an occupant with the unaided eye and is in continuous physical contact, the skin material plays a desired role in terms of design. For such a skin material, suede has often been used for high-class sensibility in the related art.

As an example, Korean Patent Application Laid-Open No. 10-2004-0029264 discloses a method for preparing suede using a non-woven fabric made by using microfiber with a denier of 0.2 or less. However, the suede produced by the production method as described above is high-grade suede, and has a disadvantage in that the suede is used limitedly only for a high-grade car model due to the high price of the raw material. Furthermore, in the case of an artificial leather fabric in the related art, which is applied to a headliner, a filler, and a sun visor for a vehicle, a large area may be constructed in order to unify the surface sensibility of a product, so that the application of the above-described high-grade suede causes costs to be significantly increased.

Meanwhile, in general, in a method for producing high-grade suede, after suede is woven, the suede is impregnated in an oil-based polyurethane (PU) solution in order to impart smooth texture and fullness feeling similar to suede of natural leather. In an oil-based polyurethane solution, dimethylformamide (DMF) is used as an organic solvent, suede woven with non-woven fabric is impregnated in the oil-based polyurethane solution, washing and drying processes are performed after the coagulation, dimethylformamide is removed, but dimethylformamide in the suede remains, so that the production method thereof is not eco-friendly.
(Patent Document 1) KR 10-2004-0029264 (Publication date: Apr. 6, 2004)

The above information disclosed in this Background section is only for enhancement of understanding of the background of the present disclosure, and therefore it may contain information that does not form the prior art that is already known to a person of ordinary skill in the art.

### SUMMARY

The present disclosure provides a suede-like artificial leather suitable for use in a headliner, a filler, and a sun visor for a vehicle, which is excellent in sensibility such as smooth texture and fullness while satisfying physical properties desired as suede that is used for a vehicle interior part.

The present disclosure also provides a method for producing suede-like artificial leather suitable for a headliner and a filler which are eco-friendly, which may implement sensibility and surface properties at levels which are equivalent to those of a high-grade suede by impregnating the suede with an aqueous polyurethane two liquid-type solution.

The present disclosure provides suede-like artificial leather of a knitted fabric which includes a covering yarn including a core and a sea-island type microfiber surrounding the core, and satisfies the following Equation 1. Equation 1 is 3≤[(A/100)×(B)]/[C]≤80, and here, A is the number of twists of a sea-island type microfiber surrounding 1 meter of the core, B is the number of filaments after the weight reduction of the sea-island type microfiber, and C is the single-yarn fineness of the core.

A sea component of the sea-island type microfiber may be a co-polymerized polyester in which isophthalate and polyalkylene glycol are co-polymerized.

An island component of the sea-island type microfiber may be Nylon 6, polyethylene terephthalate, or polyethylene.

A of Equation 1 may be 300 to 500 times.

B of Equation 1 may be a 5 to 16 split yarn.

C of Equation 1 may be 1 to 5 denier.

A single-yarn fineness after the weight reduction of the sea-island type microfiber may be a 0.01 to 0.5 denier.

The core may be a polyester-based high shrinkage yarn.

A weight ratio of the core to the sea-island type microfiber in the covering yarn after the weight reduction of the sea-island type microfiber may be 15:85 to 30:70.

The above-described suede-like artificial leather may be applied to a headliner for a vehicle, a filler for a vehicle, and a sun visor for a vehicle.

A method for producing suede-like artificial leather of the present disclosure may include: (a) forming the above-described covering yarn; (b) forming a knitted fabric by knitting the covering yarn; and (c) reducing the weight of a sea-island type microfiber by putting the knitted fabric into an alkali solution.

In one aspect, air pressure in step (a) may be 1 to 5 kg/cm².

In one aspect, a weight of the knitted fabric in step (b) may be 250 to 290 g/yd.

In one aspect, a degree of thickening of the knitted fabric in step (b) may be 0.2 to 0.8 mm.

In one aspect, the alkali solution in step (c) may be a 0.5 to 3% liquid caustic soda.

In one aspect, the temperature in step (c) may be 85 to 95° C.

In one aspect, the time in step (c) may be 15 to 40 minutes.

In one aspect, the weight reduction rate in step (c) may be 15 to 35%.

In one aspect, the method may further include (d) primarily buffing the weight-reduced knitted fabric in step (c) with sandpaper.

In one aspect, the sandpaper may be sandpaper with a mesh of 100 to 180.

In one aspect, the method may further include: (e) dyeing the knitted fabric which is primarily buffed.

In one aspect, the temperature in step (e) may be 100 to 150° C.

In one aspect, the method may further include: (f) secondarily buffing the dyed knitted fabric with sandpaper.

In one aspect, the sandpaper in step (f) may be sandpaper with a mesh of 150 to 320.

In one aspect, the knitted fabric with the reduced weight may be impregnated in a two liquid-types impregnation solution containing polyurethane.

In one aspect, the two liquid-types impregnation solution may include 100 parts by weight of an aqueous polyurethane resin, 10 to 25 parts by weight of a curing agent, and 0.1 to 10 parts by weight of an additive.

In one aspect, the aqueous polyurethane resin may be one or more selected from polyester polyurethane, polyether polyurethane, polycarbonate polyurethane, polyacetal polyurethane, polyacrylate polyurethane, polyester amide polyurethane, polythioether polyurethane, and polyolefin polyurethane.

In one aspect, the curing agent may be one or more selected from an isocyanate-based curing agent, a carbodiimide-based curing agent, and an aziridine-based curing agent.

In one aspect, the additive may be one or more selected from a light stabilizer, a dispersing agent, a leveling agent, an antifoaming agent, and a matting agent.

In one aspect, the two liquid-type impregnation solution may have a viscosity of 100 to 250 cps at 25° C.

In one aspect, the knitted fabric may be impregnated while passing through a water bath containing the two liquid-types impregnation solution.

In one aspect, the content of the polyurethane to be impregnated may be 20 to 50 g/linear meter.

In one aspect, the impregnated knitted fabric may be flame-retardant treated.

In one aspect, the flame-retardant treated knitted fabric may be heat-treated.

In one aspect, the heat treatment temperature may be 130 to 150° C.

The present disclosure may provide suede-like artificial leather suitable for use in a headliner, a filler, and a sun visor for a vehicle, which is excellent in sensibility such as smooth texture and fullness while satisfying physical properties desired as the suede that is used for a vehicle interior part.

The present disclosure may provide a method for producing suede-like artificial leather suitable for a headliner and a filler which are eco-friendly, which may implement sensibility and surface properties at levels which are equivalent to those of high-grade suede by impregnating the suede with an aqueous polyurethane two liquid-type solution.

Further areas of applicability will become apparent from the description provided herein. It should be understood that the description and specific examples are intended for purposes of illustration only and are not intended to limit the scope of the present disclosure.

### DETAILED DESCRIPTION

The following description is merely exemplary in nature and is not intended to limit the present disclosure, application, or uses.

Hereinafter, the present disclosure will be described in detail. However, the present disclosure is not limited or restricted by exemplary forms and effects of the present disclosure will be naturally understood or become apparent from the following description, and the effects of the present disclosure are not limited by only the following description. Further, in the description of the present disclosure, when it is determined that the detailed description for the publicly-known technology related to the present disclosure can unnecessarily obscure the gist of the present disclosure, the detailed description thereof will be omitted.

According to a method for producing a fabric, the fabric may be divided into a woven fabric and a knitted fabric. The woven fabric is a fabric formed by intertwining two yarns in the horizontal and vertical directions, and a yarn in the vertical direction, that is, a warp yarn and a yarn in the horizontal direction, that is, a weft yarn are intertwined with each other. The woven fabric is divided into plain weave, twill weave, and satin weave according to the production method thereof. The woven fabric has a strong structure, but is not stretchable, and thus has a disadvantage in that the workability deteriorates when attached to a vehicle interior part. The knitted fabric is made by continuously knitting a ring with a single yarn unlike the woven fabric, and is divided into a circular knit in which yarns are fed in a weft yarn direction to form a fabric and a tricot knit in which yarns are fed in a warp yarn direction to form a fabric according to the production method thereof, and the knitted fabric belongs to a method for producing a fabric having good stretchability. The present disclosure relates to suede-like artificial leather produced using a fabric of a knitted fabric, and a production method thereof.

Specifically, the present disclosure may provide knitted suede-like artificial leather of a knitted fabric which includes a covering yarn including a core and a sea-island type microfiber surrounding the core, and satisfies the following Equation 1. Equation 1 is 3≤[(A/100)×(B)]/[C]≤80, and here, A is the number of twists of a sea-island type microfiber surrounding 1 meter of the core, B is the number of filaments after the weight reduction of the sea-island type microfiber, and C is the single-yarn fineness of the core.

The reason why a yarn used in the suede-like artificial leather of the present disclosure is limited to a covering yarn satisfying conditions of Equation 1 is that when a covering yarn including a core and a sea-island type microfiber surrounding the core, which satisfies conditions of Equation 1, is used, it is possible to form suede which is excellent in sensibility such as smooth texture and fullness while satisfying physical properties desired as suede that is used for a vehicle interior part, and in particular, A, B, and C of Equation 1 have a very desired effect on the determination of the physical properties and sensibility described above.

The range of Equation 1 may be 3 to 80 or 10 to 80. When the range is less than the aforementioned range, the sensibility such as smooth texture and fullness may deteriorate, and when the range is more than the aforementioned range, the elongation and strength desired as suede that is used for a vehicle interior part may not be satisfied, so that the workability may deteriorate. Therefore, a value within the range may be selected.

The sea-island type microfiber is also referred to as a split-type microfiber, and is a sea-island type composite fiber obtained by placing and spinning a combination of two or more resins including the sea component and the island component which are remarkably different in alkali solubility characteristics, and it is possible to achieve micronization of the filaments by using an alkali solution to allow a sea component to be eluted and only an island component to remain.

A specific example of the sea-island type microfiber constituting the present disclosure may be a sea-island type composite fiber obtained by placing and spinning a combination of two or more resins in which the sea component is a co-polymerized polyester in which isophthalate and polyalkylene glycol are co-polymerized and the island component is Nylon 6. Further, another example of the sea-island type microfiber may be a sea-island type composite fiber obtained by placing and spinning a combination of two or more resins in which the sea component is a co-polymerized polyester in which isophthalate and polyalkylene glycol are co-polymerized and the island component is polyethylene terephthalate. In addition, still another example of the sea-island type microfiber may be a sea-island type composite fiber obtained by placing and spinning a combination of two or more resins in which the sea component is a co-polymerized polyester in which isophthalate and polyalkylene glycol are co-polymerized and the island component is polyethylene. The type of above-described sea-island type microfiber is only an example, and the sea-island type microfiber included in the present disclosure is not limited thereto.

The number of twists (A) of sea-island type microfiber surrounding a core may be 300 to 500 times or 350 to 500 times per 1 meter of the core. When the number of twists (A) is less than the range, smooth texture and fullness deteriorate, and when the number of twists (A) is more than the range, the elongation and strength desired as a suede that is used for a vehicle interior part fail to be satisfied, so that the workability is not good, and therefore, the number of twists (A) may fall within the aforementioned range.

The sea-island type microfiber after the weight reduction may be a split yarn with the number of filaments (B) of 5 to 16 or 8 to 16. When the number of filaments (B) is less than the range, smooth texture and fullness deteriorate, and when the number of filaments (B) is more than the range, the elongation and strength desired as the suede that is used for a vehicle interior part fail to be satisfied, so that the workability is not good, and therefore, the number of filaments (B) may fall within the aforementioned range.

The single-yarn fineness after the weight reduction of the sea-island type microfiber may be a 0.01 to 0.5 denier or a 0.01 to 0.3 denier. When the single-yarn fineness is less than the range, the sea-island type microfiber is not economically feasible because a large number of twists may be used to secure a desired texture, and when the single-yarn fineness is more than the range, the buffing process is not easily performed, and smooth texture and fullness may not be obtained, so that a denier may fall within this range.

The core is a polyester-based high shrinkage yarn and may have a single-yarn fineness (C) of 1 to 5 denier or 1 to 3 denier. When the single-yarn fineness is less than the range, the elasticity deteriorates, and when the single-yarn fineness is more than the range, the processability in the post-processing such as a buffing process after suede is woven deteriorates, and furthermore, the sensibility deteriorates, so that a denier may fall within the range.

The weight ratio of the core to the sea-island type microfiber in the covering yarn after the weight reduction of a knitted fabric using the covering yarn may be 15:85 to 30:70. When the weight ratio of the core is less than the range, the weight of the sea-island type microfiber is relatively increased, so that the sensibility may be good, but the elongation and strength desired as the suede that is used for a vehicle interior part failed to be satisfied, so that the workability is not good, and when the weight ratio of the core is more than the range, the sensibility deteriorates because the weight of the sea-island type microfiber is relatively reduced, so that it a weight ratio may fall within the range.

A method for producing suede-like artificial leather of the present disclosure may include: (a) forming the above-described covering yarn; (b) forming a knitted fabric by knitting the covering yarn; and (c) reducing the weight of a sea-island type microfiber by putting the knitted fabric into an alkali solution.

In step (a), the description on the core and the sea-island type microfiber surrounding the core is the same as that described above, so that the overlapped description thereof will be omitted. In step (a), air texturing may be performed at an air pressure of 1 to 5 kg/cm², or 1.5 to 4 kg/cm², by supplying the core and the sea-island type microfiber surrounding the core to interlace. When the air pressure is less than the range, the number of twists (A) of the sea-island type microfiber is so small that smooth texture and fullness deteriorate, and when the air pressure is more than the range, the number of twists (A) of the sea-island type microfiber is so large that the elongation deteriorates, and therefore, air texturing may be performed at an air pressure within the range.

Step (b) is a step of producing a knitted fabric using the covering yarn produced by step (a). The knitted fabric may be a circular knit produced by feeding yarns in a weft yarn direction, or a tricot knit produced by feeding yarns in a warp yarn direction.

A weight of the knitted fabric in step (b) may be 250 to 290 g/yd. When the weight of the knitted fabric is less than the range, the moldability deteriorates and wrinkles are increased, and when the weight of the knitted fabric is more than the range, the weight of the knitted fabric is so large that the elongation deteriorates, and therefore, the weight of the knitted fabric may be a weight within the range.

A degree of thickening of the knitted product in step (b) may be 0.2 to 0.8 mm. When the degree of thickening is less than the range, the strength is too weak, and when the degree of thickening is more than the range, the workability deteriorates when a part is molded, so that a degree of thickening within the range may be implemented.

Step (c) is a step in which by putting the knitted fabric into an alkali solution, the sea component of the sea-island type microfiber is eluted, and as a result, only a filament including the island component remains, and a liquid caustic soda may be used at a concentration of 0.5 to 3%, or 0.5 to 2%, as the alkali solution. When the concentration is less than the range, the weight is not appropriately reduced, and when the concentration is more than the range, the weight is excessively reduced, so that the overall quality may deteriorate, and therefore, a concentration within the range may be employed.

In step (c), when the weight is reduced such that a fine suede surface is produced, treatment may be performed at treatment conditions of 85 to 95° C. and 15 to 40 minutes.

The weight reduction rate in step (c) is 15 to 35%, or 20 to 30%. The weight reduction rate is a value derived as (the weight of the knitted fabric before the weight reduction−the weight of the knitted fabric after the weight reduction)×100/(the weight of the knitted fabric before the weight reduction), and when the weight reduction rate is less than the range, the micronization effect of the sea-island type microfiber according to the weight reduction is not properly exhibited, and when the weight reduction rate is more than the range, the deterioration in morphological stability according to the excessive weight reduction causes appearance defect and deterioration in strength of a product, so that the weight reduction rate may fall within the aforementioned range.

Step (d) is a step of allowing a dye during a subsequent dyeing work to permeate well into a knitted fabric which is subjected to weight reduction treatment through step (c) by primarily buffing the knitted fabric with sandpaper. In step (d), a method of starting the buffing work from sandpaper with #100 (100 mesh) and finishing the buffing work with sandpaper with gradually fine #180 (180 mesh) is effective, and it is also effective to weakly treat the knitted fabric with sandpaper with #180 (180 mesh), if desired.

Step (e) is a step of dyeing the primarily buffed knitted fabric through step (d) so as to implement suede having a desired color. Step (e) may be a step of dyeing the primarily buffed knitted fabric through step (d) by using a dispersion dye at 100 to 150° C. When the temperature is less than the temperature range, the dispersion dye does not permeate well into the fiber, so that the dye efficiency deteriorates, and when the temperature is more than the temperature range, the dye is decomposed, so that the dye efficiency deteriorates, and therefore, it may be desirable to dye the primarily buffed knitted fabric at a temperature within the temperature range.

Step (f) is a step of tidying up the appearance of a product by secondarily buffing the dyed knitted fabric with sandpaper. In step (f), a method of starting the buffing work from sandpaper with #150 (150 mesh) and finishing the buffing work with sandpaper with gradually fine #320 (320 mesh) is effective, and the knitted fabric may be weakly treated with sandpaper with #220 (220 mesh), if desired.

Through step (c), the knitted fabric with the reduced weight may be impregnated in a two liquid-type impregnation solution containing polyurethane, and it is possible to strengthen surface properties of the knitted fabric and tidy up the appearance by impregnating the secondarily buffed knitted fabric through step (f) with a two liquid-type solution, and the method may be divided into step (g). The two liquid-type impregnation solution may include 100 parts by weight of an aqueous polyurethane resin, 10 to 25 parts by weight of a curing agent, and 0.1 to 10 parts by weight of an additive.

The aqueous polyurethane resin is a water-dispersion polyurethane resin, examples thereof include polyester polyurethane, polyether polyurethane, polycarbonate polyurethane, polyacetal polyurethane, polyacrylate polyurethane, polyester amide polyurethane, polythioether polyurethane, polyolefin polyurethane, and the like. It is possible to use a polycarbonate polyurethane which is excellent in hydrolysis resistance and heat resistance.

Examples of the curing agent include isocyanate-based, carbodiimide-based, aziridine-based curing agents, and the like, but are not limited thereto. The curing agent may be included in an amount of 10 to 25 parts by weight, or 10 to 20 parts by weight based on 100 parts by weight of the aqueous polyurethane resin. When the content is less than the range, the curing reaction time is prolonged, or the curing reaction does not sufficiently occur, and when the content is more than the range, the unreacted curing agent remains as an impurity, so that the usability deteriorates, and therefore, the curing agent may be used within the aforementioned range.

Examples of the additive include one or more selected from a light stabilizer, a dispersing agent, a leveling agent, an antifoaming agent, and a matting agent, but are not limited thereto.

The two liquid-type impregnation solution may have a viscosity of 100 to 250 cps or 100 to 200 cps at 25° C. When the viscosity is less than the range, the texture of the product becomes relatively stiff without being suave, the solution flows down, so that the efficiency deteriorates, and when the viscosity is more than the range, the solution aggregates, and thus is not impregnated well into the knitted fabric, and therefore, the viscosity may fall within the aforementioned range.

The knitted fabric may be impregnated while passing through a water bath containing a two liquid-type impregnation solution, and the two liquid-type solution smoothly permeates into the fabric of the knitted fabric.

The content of the polyurethane to be impregnated may be 20 to 50 g/linear meter, or 25 to 40 g/linear meter. When the content is less than the range, the elongation deteriorates, and when the content is more than the range, the feeling of a polyurethane filler is predominantly exhibited instead of the inherent surface effect of suede-like artificial leather, so that the knitted fabric is impregnated in a content that falls within the aforementioned range.

The impregnated knitted fabric may be flame-retardant treated, and the method may be divided into step (h). Step (h) is a step of imparting flame retardancy to the suede-like artificial leather by treating the rear surface of the knitted fabric with a flame retardant. In the method of treating a knitted fabric with a flame retardant, the knitted fabric may be treated using a mesh roll.

The flame-retardant treated knitted fabric may be heat-treated, and the method may be divided into step (i). Step (i) may be a step of adjusting the width of a product by heat-treating the knitted fabric that is flame-retardant treated by step (h) at 130 to 150° C. for approximately 120 seconds in a tenter. When the heat treatment temperature is more than the temperature range, the impregnated polyurethane is yellowed and cured, so that the touch becomes stiff, and therefore, the knitted fabric may be heat-treated within this temperature range.

The suede-like artificial leather of the present disclosure has an effect in that sensibility such as smooth texture and fullness is excellent while satisfying physical properties desired as suede used for a vehicle interior part. In addition, the method for producing suede-like artificial leather of the present disclosure is eco-friendly because dimethylformamide does not remain by impregnating the suede with an aqueous polyurethane two liquid-type solution instead of an oil-based polyurethane solution, and may implement both sensibility and surface properties at levels which are equivalent to those of high-grade suede.

Hereinafter, Examples will be provided to help understand the present disclosure, but the following Examples are only provided to illustrate the present disclosure, and it is apparent to those skilled in the art that various alterations and modifications are possible within the scope and technical spirit of the present disclosure.

### EXAMPLES

1. Production of Covering Yarn

### Example 1

A polyester-based high shrinkage yarn with a single-yarn fineness (C) of 4 to 5 denier as a single yarn and a sea-island type microfiber as a split yarn with a single yarn fineness of 0.1 to 0.5 denier after the weight reduction and the number of filaments (B) of 5 to 10 were fed to interlace and air texturing was performed at an air pressure of 2.3 kg/cm², thereby forming a covering yarn with the number of twists (A) of 300 to 400 times per 1 meter of a core.

### Example 2

A polyester-based high shrinkage yarn with a single-yarn fineness (C) of 3 to 5 denier as a single yarn and a sea-island type microfiber as a split yarn with a single yarn fineness of 0.1 to 0.5 denier and the number of filaments (B) of 10 to 12 after the weight reduction were fed to interlace and air texturing was performed at an air pressure of 2.3 kg/cm², thereby forming a covering yarn with the number of twists (A) of 300 to 400 times per 1 meter of a core.

### Example 3

A polyester-based high shrinkage yarn with a single-yarn fineness (C) of 1 to 2 denier as a single yarn and a sea-island type microfiber as a split yarn with a single yarn fineness of 0.1 to 0.5 denier and the number of filaments (B) of 15 to 16 after the weight reduction were fed to an interlace and air texturing was performed at an air pressure of 2.3 kg/cm², thereby forming a covering yarn with the number of twists (A) of 450 to 500 times per 1 meter of a core.

### Example 4

A polyester-based high shrinkage yarn with a single-yarn fineness (C) of 2 to 3 denier as a single yarn and a sea-island type microfiber as a split yarn with a single yarn fineness of 0.1 to 0.5 denier and the number of filaments (B) of 12 to 14 after the weight reduction were fed to interlace and air texturing was performed at an air pressure of 2.3 kg/cm², thereby forming a covering yarn with the number of twists (A) of 450 to 500 times per 1 meter of a core.

### Comparative Example 1

A polyester-based high shrinkage yarn with a single-yarn fineness (C) of 1 to 2 denier as a single yarn and a sea-island type microfiber as a split yarn with a single yarn fineness of 0.1 to 0.5 denier and the number of filaments (B) of 30 to 50 after the weight reduction were fed to interlace and air texturing was performed at an air pressure of 2.3 kg/cm², thereby forming a covering yarn with the number of twists (A) of 600 to 800 times per 1 meter of a core.

### Comparative Example 2

A polyester-based high shrinkage yarn with a single-yarn fineness (C) of 0.5 to 0.1 denier as a single yarn and a sea-island type microfiber as a split yarn with a single yarn fineness of 0.1 to 0.5 denier and the number of filaments (B) of 10 to 15 after the weight reduction were fed to interlace and air texturing was performed at an air pressure of 2.3 kg/cm², thereby forming a covering yarn with the number of twists (A) of 600 to 800 times per 1 meter of a core.

### Comparative Example 3

A polyester-based high shrinkage yarn with a single-yarn fineness (C) of 1 to 2 denier as a single yarn and a sea-island type microfiber as a split yarn with a single yarn fineness of 0.1 to 0.5 denier and the number of filaments (B) of 30 to 50 after the weight reduction were fed to an interlace and air texturing was performed at an air pressure of 2.3 kg/cm², thereby forming a covering yarn with the number of twists (A) of 1000 to 2000 times per 1 meter of a core.

### Comparative Example 4

A polyester-based high shrinkage yarn with a single-yarn fineness (C) of 3 to 5 denier as a single yarn and a sea-island type microfiber as a split yarn with a single yarn fineness of 0.1 to 0.5 denier and the number of filaments (B) of 10 to 15 after the weight reduction were fed to interlace and air texturing was performed at an air pressure of 2.3 kg/cm², thereby forming a covering yarn with the number of twists (A) of 30 to 50 times per 1 meter of a core.

### Comparative Example 5

A polyester-based high shrinkage yarn with a single-yarn fineness (C) of 3 to 5 denier and a sea-island type microfiber as a split yarn with a single yarn fineness of 0.1 to 0.5 denier and the number of filaments (B) of 10 to 15 after the weight reduction were joined by simple air punching, thereby forming a composite yarn.

2. Production of Suede and Measurement of Physical Properties (Elongation and Strength) and Sensibility (Smooth texture and Fullness) Thereof

1. The covering yarns in Examples 1 and 2 and Comparative Examples 1 to 4, which were produced during the production of a covering yarn, and the composite yarn in Comparative Example 5 were each knitted, thereby producing a knitted fabric with a weight of 260 g/yd and a degree of thickening of 0.6 mm. An alkali weight reduction was performed such that the weight reduction rate was 25% by putting the produced knitted fabric into a liquid flow weight reduction machine and introducing a 1.5% liquid caustic soda at 94° C. for 20 minutes. After a primary buffing with #180 sandpaper, the knitted fabric was dyed with a dispersion dye at 130° C., washed, and reduction cleaned to remove the unattached dye. After a secondary buffing with #220 sandpaper in order to tidy up the appearance of a product, polyurethane was allowed to permeate into the knitted fabric by impregnating the knitted fabric with a two liquid-type solution with a viscosity of 200 cps at 25° C. The two liquid-type solution includes 100 parts by weight of an aqueous polycarbonate polyurethane resin, 15 parts by weight of a curing agent, 1 part by weight of a dispersing agent, and 1 part by weight of an antifoaming agent. Flame retardancy was imparted to the knitted fabric by applying a flame retardant to the rear surface of the knitted fabric and the product width (131 inch) was adjusted by a heat treatment at 140° C. for approximately 120 seconds, thereby producing suede-like artificial leather.

### Comparative Example 6

In Comparative Example 6, woven suede was produced in the same manner as described above, except that a woven fabric was formed by weaving the composite yarn in Comparative Example 5 with a warp yarn and/or a weft yarn.

### Comparative Example 7

In Comparative Example 7, high-grade suede was produced in the same manner as described above, except that a non-woven fabric was produced using only a sea-island type microfiber with a single yarn fineness of 0.1 denier after the weight reduction.

### Comparative Example 8

In Example 1, a knitted suede was produced in the same manner as described above, except that a knitted fabric was formed by weaving the covering yarn in Example 1 with a warp yarn and/or a weft yarn.

Physical property such as elongation and strength and sensibility such as smooth texture and fullness of the produced suede were measured, and the results thereof are shown in the following Table 1. The elongation was measured by calculating [(a gauge length at break−an initial gauge length)/(an initial gauge length)×100] when a test specimen was stretched at a predetermined speed using a tensioning machine. The strength was measured by calculating the maximum load at break when the test specimen was stretched at a predetermined speed using a tensioning machine. The smooth texture was expressed as excellent/very good/good/fair/poor when the suede was directly touched by suede experts. The fullness was expressed as excellent/very good/good/fair/poor when the suede was directly touched by suede experts.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Value of Equation 1 | | 3~10 | 6~16 | 33~80 | 18~35 | 90~400 | 180~600 | 1500~10000 |
| Yarn used for production of suede | | Covering | Covering | Covering | Covering | Covering | Covering | Covering |
| | | yarn | yarn | yarn | yarn | yarn | yarn | yarn |
| Suede fabric | | Knitted | Knitted | Knitted | Knitted | Knitted | Knitted | Knitted |
| | | fabric | fabric | fabric | fabric | fabric | fabric | fabric |
| Physical | Elongation (%) | 112 | 102 | 115 | 120 | 75 | 84 | 73 |
| properties | Tensile strength | 150 | 148 | 150 | 147 | 121 | 90 | 132 |
| | (N/50 mm) | | | | | | | |
| | Residual reduction | 10 | 11 | 10 | 12 | 22 | 20 | 22 |
| | rate (%) | | | | | | | |
| Sensibility | Smooth texture | Excellent | Excellent | Excellent | Excellent | Very good | Good | Very good |
| | Fullness | Very good | Very good | Very good | Very good | Very good | Good | Very good |

| | | Comparative | Comparative | Comparative | Comparative | Comparative | |
|---|---|---|---|---|---|---|---|
| | | Example 4 | Example 5 | Example 6 | Example 7 | Example 8 | Criteria |
| Value of Equation 1 | | 0.6~2.5 | 0 | 0 | 0 | 3~10 | — |
| Yarn used for production of suede | | Covering | Composite | Composite | Sea-island | Covering | — |
| | | yarn | yarn | yarn | type microfiber | yarn | |
| Suede fabric | | Knitted | Knitted | Woven | Non-woven | Woven | — |
| | | fabric | fabric | fabric | fabric | fabric | |
| Physical | Elongation (%) | 90 | 99 | 65 | 58 | 67 | 90 |
| properties | Tensile strength | 141 | 138 | 145 | 250 | 155 | 100 |
| | (N/50 mm) | | | | | | |
| | Residual reduction | 17 | 17 | 24 | 25 | 24 | 17 |
| | rate (%) | | | | | | |
| Sensibility | Smooth texture | Fair | Fair | Fair | Excellent | Very good | — |
| | Fullness | Fair | Fair | Fair | Very good | Very good | — |

As confirmed from Table 1, it could be seen that the suede-like artificial leather produced using the covering yarn according to the present disclosure was excellent in both sensibility and physical properties, whereas in the suedes in Comparative Examples 1 and 3, the number of filaments and the number of twists were so large that the smooth texture and fullness were excellent, but flexibility was insufficient, so that the elongation deteriorated and the residual reduction rate was high.

It could be seen that in Comparative Example 2, the single yarn fineness of the high shrinkage yarn was so small that the elongation and strength deteriorated and the residual reduction rate was increased. It could be seen that in the suedes in Comparative Examples 4 and 5, the number of twists was too small and there is no twist, so that smooth texture and fullness deteriorated. It could be seen that in Comparative Examples 6 and 8 as a knitted suede, the elongations deteriorated as compared to the present disclosure as suede-like artificial leather, and particularly in Comparative Example 6 as a knitted suede using a composite yarn, smooth texture and fullness deteriorated. Comparative Example 7 was high-grade suede produced using only a sea-island type microfiber, and was similar to the suede of the present disclosure in terms of sensibility, but was not suitable because the elongation deteriorated due to the failure to include a high shrinkage yarn, and furthermore, the production costs were increased.

3. Measurement of Amount of Polyurethane Impregnated, Amount of Remaining DMF, Physical Properties, and Sensibility After Suede is Impregnated and Washed

### Comparative Example 9

In Comparative Example 9, a non-woven fabric with a weight of 260 g/yd and a degree of thickening of 0.6 mm was produced using only a sea-island type microfiber with a single yarn fineness of 0.1 denier after the weight reduction, and then impregnated in an oil-based polyurethane solution formed by dissolving 100 parts by weight of a polyether-based polyurethane resin, 20 parts by weight of a pigment, and 15 parts by weight of a flame retardant in 250 parts by weight of dimethylformamide as an organic solvent, thereby allowing polyurethane to be impregnated into the non-woven fabric.

Subsequently, after the coagulation at a temperature of 30° C., dimethylformamide was removed and the non-woven fabric was washed by using a hot bath at 60° C., and then dried at 150° C. for 70 seconds, and by putting the non-woven fabric into a liquid flow weight reduction machine and introducing a 1.5% liquid caustic soda at 94° C. for 20 minutes, an alkali weight reduction was performed such that the weight reduction rate was 25%, and then after a primary buffing with #180 sandpaper, the non-woven fabric was dyed with a dispersion dye at 130° C., washed, and reduction cleaned to remove the unattached dye, and after a secondary buffing with #220 sandpaper in order to tidy up the appearance of a product, the appearance of the knitted fabric was tidied up by impregnating the non-woven fabric with an aqueous surface treatment agent with a viscosity of 400 cps at 25° C.

The aqueous surface treatment agent included 100 parts by weight of an aqueous polycarbonate polyurethane resin, 10 parts by weight of a curing agent, 1 part by weight of a dispersion agent, 1 part by weight of a leveling agent, and 5 parts by weight of a thickening agent. Subsequently, flame retardancy was imparted to the knitted fabric by applying a flame retardant to the rear surface of the knitted fabric and the product width (131 inches) was adjusted by a heat treatment at 140° C. for 120 seconds, and then a high-grade suede was produced.

### Comparative Example 10

The suede-like artificial leather was produced in the same manner as in Example 1, except that as a surface treatment agent when compared to Example 1, the surface treatment agent used in Comparative Example 9 was used.

The amount of polyurethane impregnated, the amount of remaining dimethylformamide, the physical properties, and the sensibility in Example and Comparative Examples 9 and 10 were measured, and are shown in the following Table 2.

TABLE 2

| | | Comparative | Comparative |
|---|---|---|---|
| | Example 1 | Example 9 | Example 10 |
| Suede fabric | Knitted | Non-woven | Knitted |
| | fabric | fabric | fabric |
| Amount (g/linear meter) of | 30 | 35 | 0 |
| polyurethane impregnated | | | |
| Amount (g) of remaining | 0 | 8 | 0 |
| dimethylformamide | | | |
| Elongation (%) | 112 | 55 | 105 |
| Strength (kgf/50 mm) | 150 | 248 | 153 |
| Smooth texture | Excellent | Excellent | Good |
| Fullness | Very good | Very good | Good |

As confirmed from Table 2, it can be seen that in Example 1 as the suede-like artificial leather according to the present disclosure, the amount of polyurethane impregnated by impregnation with an aqueous polyurethane two liquid-type solution is similar to that of Comparative Example 9 in which a wet process of impregnation in an oil-based polyurethane solution is performed, so that Example 1 may have sensibility at a level which is equivalent to that of high-grade suede while having excellent physical properties.

Further, it can be seen that the suede-like artificial leather of the present disclosure is treated with a two liquid-type solution including aqueous polyurethane, and thus is eco-friendly because the suede-like artificial leather according to the present disclosure does not include dimethylformamide as an organic solvent and as a result, the remaining dimethylformamide is 0 g. In addition, it can be seen that in Comparative Example 10, a gravure coating is performed using a high viscosity aqueous surface treatment agent with a surface treatment agent viscosity of 400 cps at 25° C. without performing a polyurethane impregnation process, so that smooth texture and fullness deteriorate significantly because the amount of polyurethane impregnated in Comparative Example 10 is very small as compared to that in Example 1.

The present disclosure has been described in detail through representative Examples, but it is to be understood by a person with ordinary skill in the art to which the present disclosure pertains that various modifications are possible in the above-described Examples within the range not departing from the scope of the present disclosure. Therefore, the scope of the present disclosure should not be limited to the above-described Examples but should be determined by not only the claims to be described below but also all the changes or modified forms derived from the claims and the equivalent concept thereof.

While this present disclosure has been described in connection with what is presently considered to be practical exemplary forms, it is to be understood that the present disclosure is not limited to the disclosed forms, but, on the contrary, it is intended to cover various modifications and equivalent arrangements included within the spirit and scope of the present disclosure.

What is claimed is:

1. Suede-like artificial leather of a knitted fabric which comprises a covering yarn comprising:
a core; and
a sea-island type microfiber surrounding the core, and satisfies the following Equation 1:
3≤[(A/100)×(B)]/[C]≤80 [Equation 1]
wherein A is a number of twists of the sea-island type microfiber surrounding 1 meter of the core, B is a number of filaments after weight reduction of the sea-island type microfiber, and C is a single-yarn fineness of the core.

2. The suede-like artificial leather of claim 1, wherein a sea component of the sea-island type microfiber is a co-polymerized polyester in which isophthalate and polyalkylene glycol are co-polymerized.

3. The suede-like artificial leather of claim 1, wherein an island component of the sea-island type microfiber is Nylon 6, polyethylene terephthalate, or polyethylene.

4. The suede-like artificial leather of claim 1, wherein A of Equation 1 is 300 to 500 times.

5. The suede-like artificial leather of claim 1, wherein B of Equation 1 is a 5 to 16 split yarn.

6. The suede-like artificial leather of claim 1, wherein C of Equation 1 is a 1 to 5 denier.

7. The suede-like artificial leather of claim 1, wherein a single-yarn fineness after the weight reduction of the sea-island type microfiber is a 0.01 to 0.5 denier.

8. The suede-like artificial leather of claim 1, wherein the core is a polyester-based high shrinkage yarn.

9. The suede-like artificial leather of claim 1, wherein a weight ratio of the core to the sea-island type microfiber in the covering yarn after the weight reduction of the sea-island type microfiber is 15:85 to 30:70.

10. A method for producing suede-like artificial leather, the method comprising:
(a) forming the covering yarn of claim 1;
(b) forming a knitted fabric by knitting the covering yarn; and
(c) reducing a weight of a sea-island type microfiber by putting the knitted fabric into an alkali solution to form a weight-reduced knitted fabric.

11. The method of claim 10, wherein air pressure in step (a) is 1 to 5 kg/cm².

12. The method of claim 10, wherein a weight of the knitted fabric in step (b) is 250 to 290 g/yd.

13. The method of claim 10, wherein a degree of thickening of the knitted fabric in step (b) is 0.2 to 0.8 mm.

14. The method of claim 10, wherein a temperature in step (c) is 85° C. to 95° C., and a time in step (c) is 15 minutes to 40 minutes.

15. The method of claim 10, wherein a weight reduction rate in step (c) is 15 to 35%.

16. The method of claim 10, wherein the weight-reduced knitted fabric is impregnated in a two liquid-type impregnation solution containing polyurethane to define an impregnated knitted fabric.

17. The method of claim 16, wherein the two liquid-type impregnation solution comprises 100 parts by weight of an aqueous polyurethane resin, 10 to 25 parts by weight of a curing agent, and 0.1 to 10 parts by weight of an additive.

18. The method of claim 16, wherein the two liquid-type impregnation solution has a viscosity of 100 to 250 cps at 25° C.

19. The method of claim 16, wherein the knitted fabric is impregnated while passing through a water bath containing the two liquid-type impregnation solution.

20. The method of claim 16, wherein a content of the aqueous polyurethane resin to be impregnated is 20 to 50 g/linear meter.
